(19) United States
(12) Patent Application Publication
(10) Pub. No.: US 2015/0087331 A1
(43) Pub. Date: Mar. 26, 2015

(54) METHOD AND APPARATUS OF WI-FI-BASED POSITIONING

(71) Applicant: Samsung Electronics Co., Ltd., Suwon-si (KR)

(72) Inventors: Chouchang Yang, Seattle, WA (US); Huai-Rong Ngo, San Jose, CA (US); Chiu Ngo, Millbrae, CA (US)

(73) Assignee: Samsung Electronics Co., Ltd., Suwon-si (KR)

(21) Appl. No.: 14/292,706

(22) Filed: May 30, 2014

Related U.S. Application Data
(60) Provisional application No. 61/882,560, filed on Sep. 25, 2013.

(51) Int. Cl. H04W 4/02

(52) U.S. Cl. CPC H04W 4/023
USPC 455/456.1

(57) ABSTRACT

A method and system for providing Wi-Fi positioning. The method includes transmitting multiple messages by an electronic device. A received signal is reconstructed using the multiple messages by another electronic device. Each message of the multiple messages is arranged in a particular order for reconstructing the received signal through a determination of relative time difference between the multiple messages.

### CROSS-REFERENCE TO RELATED APPLICATIONS

This application claims the priority benefit of U.S. Provisional Patent Application Ser. No. 61/882,560, filed Sep. 25, 2013, incorporated herein by reference in its entirety.

### TECHNICAL FIELD

One or more embodiments generally relate to Wi-Fi position determination, in particular, to determining position using Wi-Fi based on time of arrival combined with angle of arrival.

### BACKGROUND

Determining position indoors (e.g., a dwelling, shopping mall, school, etc.) may be used for different applications, such as targeting information. Use of traditional location based position determinations, such as global positioning system (GPS), may not be available or may be inaccurate in an indoor situation.

### SUMMARY

One or more embodiments generally relate to Wi-Fi positioning. In one embodiment, the method includes transmitting multiple messages by an electronic device. In one embodiment, a received signal is reconstructed using the multiple messages by another electronic device. In one embodiment, each message of the multiple messages is arranged in a particular order for reconstructing the received signal through a determination of relative time difference between the multiple messages.

In one embodiment, a system is provided that includes one or more access points (APs) or station devices (STAs) and an electronic device that reconstructs a received signal from the one or more APs or STAs using multiple messages. In one embodiment, the electronic device further arranging each message of the multiple messages in a particular order for reconstructing the received signal through a determination of relative time difference between the multiple messages.

In one embodiment a non-transitory computer-readable medium having instructions which when executed on a computer perform a method comprising: transmitting multiple messages from an electronic device. In one embodiment, a received signal is reconstructed using the multiple messages by another electronic device. In one embodiment, each message of the multiple messages is arranged in a particular order for reconstructing the received signal through a determination of relative time difference between the multiple messages.

These and other aspects and advantages of one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of architecture for a system including a Wi-Fi device (e.g., Access point (AP)), according to an embodiment.

FIG. 3 shows an example time of arrival (TOA) positioning approach.

FIG. 4 shows an example angle of arrival (AOA) positioning approach.

FIG. 5A shows an example Wi-Fi positioning for a single AP, according to an embodiment.

FIG. 5B shows an example Wi-Fi positioning for multiple APs, according to an embodiment.

FIG. 6 shows an example graph for received signal sampling, according to one embodiment.

FIG. 7 shows an example time shift property, according to an embodiment.

FIG. 8 shows an example graph for reconstruction of received signals, according to an embodiment.

FIG. 9 shows an example graph of AOA estimation vs. sampling position, according to an embodiment.

FIG. 10 shows an example timing-based flow diagram, according to an embodiment.

FIG. 11A shows an example graph of TOA performance for a sample of ten (10) packets, according to an embodiment.

FIG. 11B shows an example graph of AOA performance for a sample of ten (10) packets, according to an embodiment.

FIG. 12A shows an example graph of TOA performance for a sample of twenty (20) packets, according to an embodiment.

FIG. 12B shows an example graph of AOA performance for a sample of twenty (20) packets, according to an embodiment.

FIG. 13 shows an example chart of positioning performance for a sample of ten (10) packets, according to an embodiment.

FIG. 14 shows an example chart of positioning performance for a sample of twenty (20) packets, according to an embodiment.

FIG. 15 shows a process for Wi-Fi positioning, according to one embodiment.

FIG. 16 is a high-level block diagram showing an information processing system comprising a computing system implementing one or more embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

Embodiments relate to Wi-Fi positioning (e.g., position determination). In one embodiment, a method includes transmitting multiple messages by an electronic device. In one embodiment, a received signal is reconstructed using the multiple messages by another electronic device. In one embodiment, each message of the multiple messages is arranged in a particular order for reconstructing the received signal through a determination of relative time difference between the multiple messages.

One or more embodiments provide a Wi-Fi based real-time accurate indoor positioning approach using multiple messages instead of one to obtain higher sampling resolutions. In one embodiment, the time of arrival (TOA) and angle of arrival (AOA) estimation may be determined without having restrictions from hardware constraints, such as bandwidth and number of antennas for electronic devices (e.g., for an access point (AP) or station device (STA)). One or more embodiments provide positioning accuracy up to 1 meter for a sampling rate of 40 MHz, while using a single Wi-Fi AP; and when using multiple Wi-Fi APs, the accuracy may be increased to 0.5 meter for a sampling rate of 40 MHz.

One or more embodiments provide an indoor Wi-Fi positioning system that exploits the use of Wi-Fi systems without changing the hardware design of traditional Wi-Fi systems. In one embodiment, multiple messages and phase rotation information are used, such that the samples from different messages are arranged to reconstruct the received signal in a higher resolution.

In one embodiment, unlike conventional super-resolution positioning approaches which only use one timing message, multiple messages that have the same patterns are used to assist the receiver (e.g., a mobile electronic device) estimate TOA with greater accuracy. Since the channel state information may be assumed to be stationary during a short time interval at an indoor location, multiple received messages are used in order to reconstruct the received signal such that the estimation performance will not be limited by a signal's bandwidth.

In one embodiment, combining the TOA technique as described above, channel estimation is used to obtain AOA from an orthogonal frequency-division multiplexing (OFDM) system such that the line of sight (LOS) angle may be obtained without a large numbers of antennas to mitigate multipath affection. In order to estimate better AOA, one or more embodiments use multiple messages to reconstruct a received signal, then, by using pilot signal techniques, the AOA is estimated for LOS.

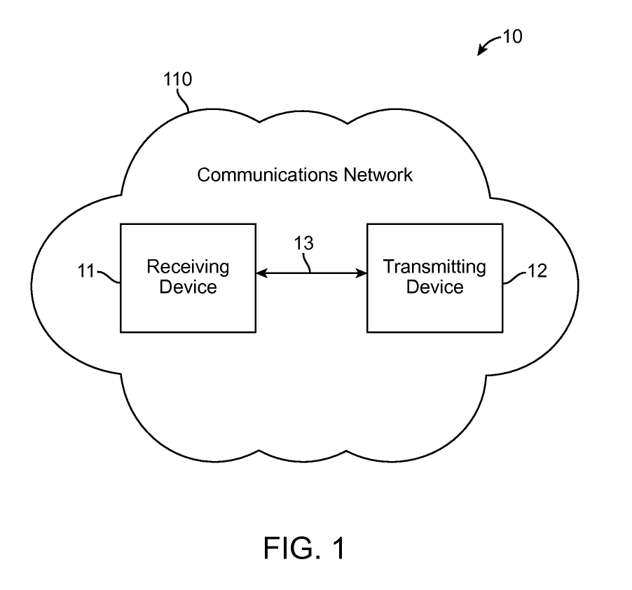

FIG. 1 is a schematic view of a communications system 10, in accordance with one embodiment. Communications system 10 may include a communications device that initiates an outgoing communications operation (transmitting device 12) and a communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include multiple transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., an IEEE 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, the communications network 110 may support protocols used by wireless and cellular phones and personal email devices (e.g., a Blackberry®). Such protocols may include, for example, GSM, GSM plus EDGE, CDMA, quadband, and other cellular protocols. In another example, a long range communications protocol can include Wi-Fi and protocols for placing or receiving calls using VOIP, LAN, WAN, or other TCP-IP based communication protocols. The transmitting device 12 and receiving device 11, when located within communications network 110, may communicate over a bidirectional communication path such as path 13, or over two unidirectional communication paths. Both the transmitting device 12 and receiving device 11 may be capable of initiating a communications operation and receiving an initiated communications operation.

The transmitting device 12 and receiving device 11 may include any suitable device for sending and receiving communications operations. For example, the transmitting device 12 and receiving device 11 may include mobile telephone devices, television (TV) systems (e.g., high-definition (HD) TVs (HDTVs), ultra-high definition TVs (UDTVs), monitors, displays, cameras, camcorders, a device with audio video capabilities, tablets, wearable devices, and any other device capable of communicating wirelessly (with or without the aid of a wireless-enabling accessory system) or via wired pathways (e.g., MHL, HDMI, using traditional telephone wires, etc.). The communications operations may include any suitable form of communications, including for example, voice communications (e.g., telephone calls), data communications (e.g., e-mails, text messages, media messages), video communication, audio communication, audio-video (AV) communication, or combinations of these (e.g., video conferences).

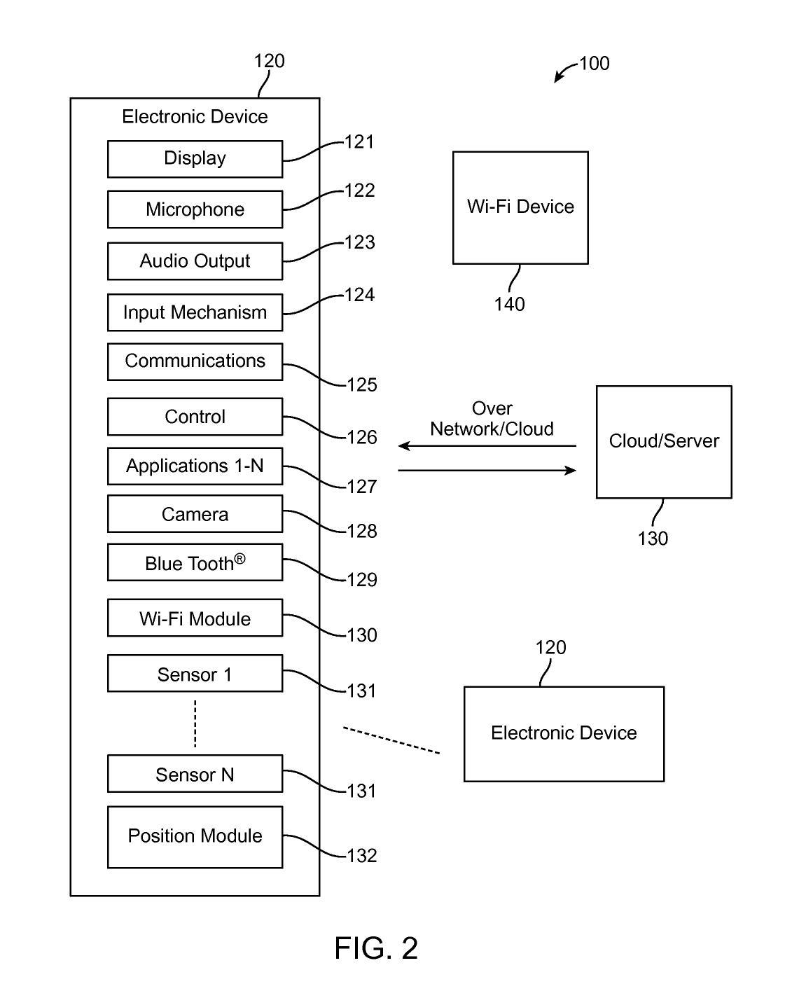

FIG. 2 shows a functional block diagram of an architecture system 100 that may be used for providing positioning for electronic device 120 using a Wi-Fi device 140 (e.g., an AP, router, etc.). Both the transmitting device 12 and receiving device 11 may include some or all of the features of the electronics device 120. In one embodiment, the electronic device 120 may comprise a display 121, a microphone 122, an audio output 123, an input mechanism 124, communications circuitry 125, control circuitry 126, Applications 1-N 127, a camera module 128, a BlueTooth® module 129, a Wi-Fi module 130, sensors 1 to N 131 (N being a positive integer), a position module 132 and any other suitable components. In one embodiment, applications 1-N 127 are provided and may be obtained from a cloud or server 130, a communications network 110, etc., where N is a positive integer equal to or greater than 1. In one embodiment, the system 100 includes a wired link 150 (e.g., MHL, HDMI, etc.) that connects the electronic device 120 with the electronic device 140. In one embodiment, the electronic device 120 may comprise a mobile device (e.g., smart phone, camera, content player, video recorder, tablet, wearable device(s), implantable devices, etc.).

In one embodiment, all of the applications employed by the audio output 123, the display 121, input mechanism 124, communications circuitry 125, and the microphone 122 may be interconnected and managed by control circuitry 126. In one example, a handheld music player capable of transmitting music to other tuning devices may be incorporated into the electronics device 120.

In one embodiment, the audio output 123 may include any suitable audio component for providing audio to the user of electronics device 120. For example, audio output 123 may include one or more speakers (e.g., mono or stereo speakers) built into the electronics device 120. In some embodiments, the audio output 123 may include an audio component that is remotely coupled to the electronics device 120. For example, the audio output 123 may include a headset, headphones, or earbuds that may be coupled to communications device with a wire (e.g., coupled to electronics device 120 with a jack) or wirelessly (e.g., Bluetooth® headphones or a Bluetooth® headset).

In one embodiment, the display 121 may include any suitable screen or projection system for providing a display visible to the user. For example, display 121 may include a screen (e.g., an LCD screen) that is incorporated in the electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., an IEEE 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, TCP-IP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM/DRAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an automatic speech recognition (ASR) application, a dialog application, a map application, a media application (e.g., QuickTime, MobileMusic.app, or MobileVideo.app), social networking applications (e.g., Facebook®, Twitter®, etc.), an Internet browsing application, etc. In some embodiments, the electronics device 120 may include one or multiple applications operative to perform communications operations. For example, the electronics device 120 may include a messaging application, a mail application, a voicemail application, an instant messaging application (e.g., for chatting), a videoconferencing application, a fax application, or any other suitable application for performing any suitable communications operation.

In some embodiments, the electronics device 120 may include a microphone 122. For example, electronics device 120 may include microphone 122 to allow the user to transmit audio (e.g., voice audio) for speech control and navigation of applications 1-N 127, during a communications operation or as a means of establishing a communications operation or as an alternative to using a physical user interface. The microphone 122 may be incorporated in the electronics device 120, or may be remotely coupled to the electronics device 120. For example, the microphone 122 may be incorporated in wired headphones, the microphone 122 may be incorporated in a wireless headset, the microphone 122 may be incorporated in a remote control device, etc.

In one embodiment, the camera module 128 comprises one or more camera devices that include functionality for capturing still and video images, editing functionality, communication interoperability for sending, sharing, etc., photos/videos, etc.

In one embodiment, the BlueTooth® module 129 comprises processes and/or programs for processing BlueTooth® information, and may include a receiver, transmitter, transceiver, etc.

In one embodiment, the electronics device 120 may include multiple sensors 1 to N 131, such as accelerometer, gyroscope, microphone, temperature, light, barometer, magnetometer, compass, radio frequency (RF) identification sensor, etc.

In one embodiment, the electronics device 120 may include any other component suitable for performing a communications operation. For example, the electronics device 120 may include a power supply, ports, or interfaces/connectors/ports for coupling to a host device, a secondary input mechanism (e.g., an ON/OFF switch), or any other suitable component.

In one embodiment, more than one Wi-Fi device 140 (e.g., two, three, etc.) may be included in the system 100. In one embodiment, the position module 132 provides position determining processing for system 100 using the Wi-Fi device 140 as described below for determining/estimating TOA and AOA.

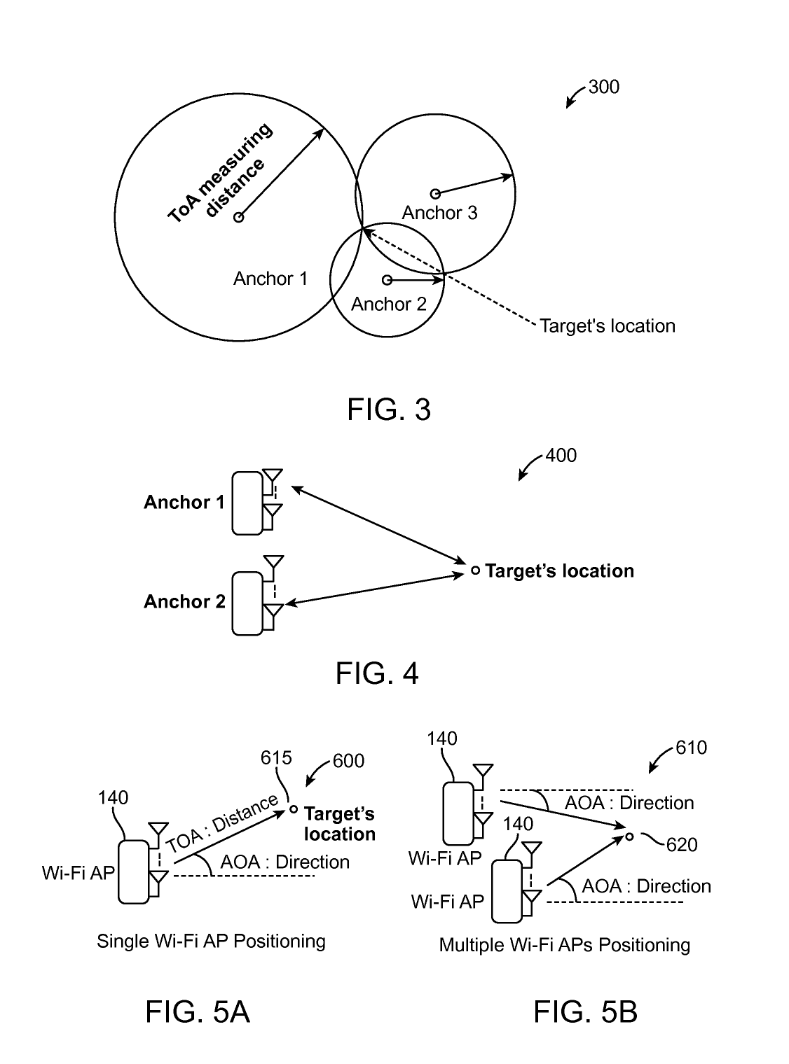

FIG. 3 shows an example TOA positioning approach as used by conventional systems. TOA is the travel time between a transmitter and a receiver. The distance can be calculated by using travel time and multiplying by the speed of light. To measure the travel time in the air, the approach in system 300 requires clock synchronization between transmitters and receivers. In addition, system 300 requires at least three anchors to have the plane-domain (2-D) localization as shown. The positioning performance of system 300 is decided by a signal's bandwidth. When a signal's bandwidth is not wide enough, the receiver cannot capture arrival time precisely. The position solution of system 300 applied for TOA is listed as Ultra Wide Band (UWB) in Table 1 below.

FIG. 4 shows an example AOA positioning approach system 400. Angle of arrival measurement is the method which can determine the incoming signal's direction from a transmitter on the antenna array. By exploiting and detecting time difference among antennas, the direction of an incoming signal can be calculated. In order to locate position, system 400 requires two anchors with antenna arrays at different places to obtain a target's position. The commercial solution applied AOA is shown in Table 1. With system 400, however, when suffering multipath affection, LOS (direct-path's ray) and non-line of sight (multi-path ray) may have different direction angles toward the receiver. By applying processing of system 400 and having more antennas than the number of multi-paths, one can associate the direction for each ray. However, the angle of the LOS is still not clear, since one can obtain multiple angles with respect to the ray's path. In addition, AOA requires a large number of antennas against multipath affection. Although changing frequency technology, such as Bluetooth® can decrease the number of antennas, it still requires a number of antennas.

The received signal strength (RSS) fingerprint is a site-survey approach for positioning. This method applies the fact that each location may experience unique environments, such that the signal has a unique fingerprint pattern with its signal strength. By associating the signal's fingerprint from a target, the anchor can deduce a possible location from a pre-measuring fingerprint database. This mechanism only requires one anchor node for positioning. A commercial solution that applied RSS fingerprint-based method is shown in Table 1 below. The RSS fingerprint approaches, however, need to employ fingerprint patterns in advance as a metric for location determination. Therefore, for a high dynamic environment, such as a shopping mall with a crowd of people, the RSS fingerprint mechanism may be hard to identify an object's position from the fingerprint database.

TABLE 1

| Current Indoor | | | |
|---|---|---|---|
| Positioning | Positioning | | |
| System | Approaches | Accuracy | Drawbacks |
| UWB System | TOA | It can | This requires a very |
| | mechanism | achieve up | wide bandwidth as well |
| | | to a | as a special hardware |
| | | center | design to have |
| | | meter | localization, which |
| | | accuracy | results in a very |
| | | | expensive cost |
| | | | regarding hardware. |
| AOA Mechanism | AOA | It can | This requires a |
| | mechanism | achieve | specific hardware |
| | | 0.5~1 | device including 16 |
| | | meter | array antennas with a |
| | | location | transmitter and tag as |
| | | accuracy. | the receiver by using |
| | | | a Bluetooth ® |
| | | | enhancement. |
| RSS | Wi-Fi RSS | It can | This requires a site |
| | fingerprint- | achieve | survey fingerprint in |
| | based | 1.75~2.18 | advance. In addition, |
| | mechanism | meter | the calculation |
| | with gyro | accuracy. | loading is O(N²) which |
| | sensors as | | exponentially |
| | side | | increases with the |
| | information | | number of fingerprint |
| | | | points N in the |
| | | | database. |

FIG. 5A shows an example Wi-Fi positioning 600 for a single AP or STA, according to an embodiment. In the example 600, a single AP Wi-Fi device 140 (or STA) is used to determine the position of a target's 615 (e.g., an electronic device 120) location. FIG. 5B shows an example 610 Wi-Fi positioning for multiple (e.g., two or more) APs Wi-Fi devices 140 (or STAs), according to an embodiment. In one embodiment, the multiple APs Wi-Fi devices 140 (or STAs) are used for determining the position of the target's 620 (e.g., an electronic device 120) location.

In one embodiment, when the Wi-Fi AP (or STA) exists as a single AP (or STA) Wi-Fi device 140 (as in system 600), hybrid AOA/TOA system 600 is used to locate the target's 615 positioning. In one embodiment, when the number of Wi-Fi AP devices 140 (or STAs) is greater than one, system 610 is applied for AOA determinations to obtain a greater accuracy location solution.

In one embodiment, the TOA determination performance is decided based on a signal's bandwidth as well as the sampling rate. In one example, when the sampling rate is low (i.e., a narrow bandwidth), TOA may not be precisely determined. A conventional method of using super-resolution estimation is based on sub-space decomposition of the autocorrelation matrix, which requires the calculation of an inverse matrix and eigenvectors. Those estimation approaches, however, result in heavy calculation loading while the improvement in positioning performance is limited.

Although TOA measurement performance is decided by the sampling rate, one or more embodiments increase TOA accuracy by using multiple same (predefined) messages to assist in the estimation. In one embodiment, since each incoming message is not sampled near the same place, the collections of multiple received messages in a linear time invariant (LTI) channel are able to be used for reconstructing the received signal at a higher resolution. In one embodiment, the received signal may be described as:

y(t)=x(t)\textcircled{×}h(t)

where
x(t): is the message sent by sender
h(t): is the channel impulse responses represent the environment affection and
\textcircled{×}: represents the convolution operation.
Similarly, the received signal after ADC may be described as:

y_{d}[n]=y(n×T_{S}+τ)+w(t)

where
y(□): is the received signal before ADC as continuous time waveform
y_{d}(□): is the received signal after ADC as discrete time waveform
w(□) is noise, such as Gaussian white noise
n: is the n-th sampling point
T_{S}: is the sampling time period and
τ: is the relative starting point of the sampling position with respect to the received signal y(t) and τε[0,T_{S}].

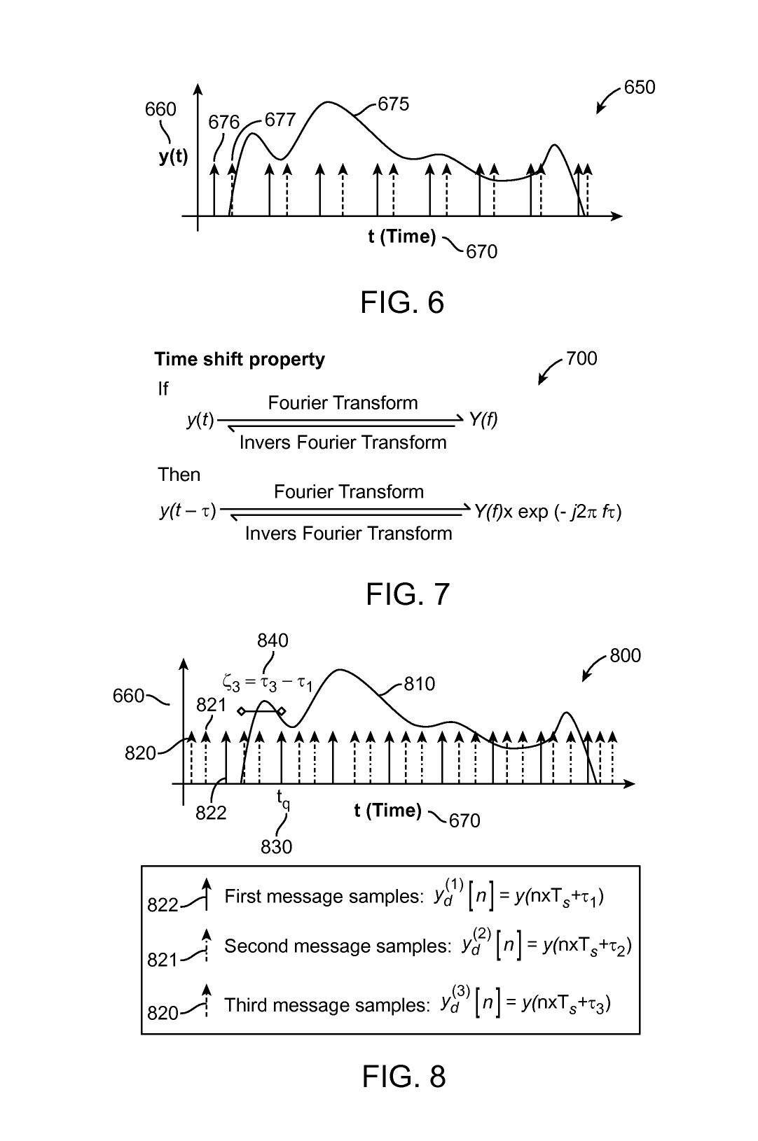

FIG. 6 shows an example graph 650 for received signal sampling, according to one embodiment. In one embodiment, if the channel is time invariant and the sender sends multiple same pre-defined messages, the received signal after sampling may be described as shown in graph 650. The black solid arrow 676 and dot arrow 677 represent two different time samplings, respectively for the same received signal y(t) 660 shown versus time (t) 670. In one embodiment, since the transmitter has sent the same multiple messages, the receiver will receive the same incoming signal y(t) 660 repeatedly.

In one embodiment, for the graph 650 it can be seen that the sampling positions 676 and 677 regarding each incoming signal 675 are not at the same positions. Therefore, in one embodiment the collection of multiple packets in the right order are used to reconstruct the received signal, while it is assumed that the channel is invariant and noise is negligible comparing with the received signal power level. In one example embodiment, the combination of the black solid samples 676 and the dot samples 677 are able to be used for reconstructing a received signal y(t) 660 at a higher resolution than just using one message alone. In one embodiment, the frequency transform property is applied as follows below to achieve the reconstruction goal.

FIG. 7 shows an example time shift property 700, according to an embodiment. The exp(−j2πfτ) results in the phase rotation −2πfτ in I-Q domain. In one embodiment, the i-th repeated message after sampling is denoted as y_{d}⁽ⁱ⁾[n]=y(n×T_{S}+τᵢ). In one embodiment, the i-th and j-th messages may be described as y_{d}⁽ⁱ⁾[n]=y(n×T_{S}+τᵢ) and y_{d}^{(j)}[n]=y(n×T_{S}+τⱼ). In one embodiment, for fast Fourier transform (FFT) size N, the time difference Δτ between two messages y_{d}⁽ⁱ⁾ and y_{d}^{(j)} at the sub-carrier F₁ may be calculated as:

$$Δ τ = {τ}_{j} - {τ}_{i} = \frac{∠ {Y}_{d}^{j} [ {F}_{l} ] - ∠ {Y}_{d}^{i} [ {F}_{l} ]}{2 π ( \frac{{F}_{l}}{N {T}_{S}} )} , \\ for {F}_{l} ∈ [ 0 , 1 , 2 , … , ( \frac{N}{2} - 1 ) ]$$

where
∠□: is the phase from I-Q channel domain
T_{S}: is the sampling time period and
Y_{d}^{j}=fft(y_{d}^{j}).

FIG. 8 shows an example graph 800 for reconstruction of received signals 810, according to an embodiment. In one embodiment, the graph 800 includes y(t) 660 versus t 670. In one embodiment, the first message samples 822, second message samples 821 and third message samples 820 are shown. In one example, the detectable arrival time ζᵢ=τᵢ−τ_{q} 840 for i=3, and detectable time of arrival from the sampled target message t_{q} 830 are shown as an example.

In one embodiment, since the phase information from the rotation in the frequency domain reflects the time shift from the sampling position, messages may be arranged with their relative time differences to reconstruct a high resolution received signal. In one embodiment, if the sender (e.g., AP Wi-Fi device 140, FIG. 2) has sent M messages with same content, then the receiver (e.g., electronic device 120) will receive M same messages denoted as y(t). Then, each message after sampling may be defined as: y_{d}⁽ⁱ⁾[n]=y(n×T_{S}+τᵢ), where 1≦i≦M. In one embodiment, the order arrangement may be performed as follows: (i) choose the target message y_{d}^{(q)}[n]=y(n×T_{S}+τ_{q}) as a reference node. (ii) arrange the message i to reconstruct the received signal y′(t) such that: y′(n×T_{S}=ζᵢ)=y_{d}⁽ⁱ⁾[n] where ζᵢ=τᵢ−τ_{q}=1, 2, . . . M. Then, in one embodiment, the y′(n×T_{S}+ζᵢ) has a higher resolution than each of the sampled messages y(n×T_{S}+τᵢ). As shown in the graph 800, by using phase as an index to obtain a relative time offset for ordering, the received signal may be reconstructed. In another embodiment, the messages may include either the same content, different content or a portion of same content and portion of different content.

In one embodiment, the reconstruction signal y′(n×T_{S}+ζᵢ only indicates the received signal in discrete time (relative timestamp). In one embodiment, the real timestamp plus the time shift from reconstruct signal y′(n×T_{S}+ζᵢ) is used to obtain the TOA. In one example embodiment, if the timestamp for the detectable TOA from the sampled target message y_{d}^{(q)}[n] is denoted as t_{q} 830, then the TOA regarding the target message is: TOA=t_{q}+ζᵢ Where ζᵢ is the detectable arrival time in the i-th message whose signal strength is larger than a threshold among y′(n×T_{S}+ζᵢ). In one example embodiment, in the graph 800 we let the first message be the target message. Then three messages are arranged as in the above order. In one example embodiment, the t_{q} 830 is the timestamp for the first sample among y_{d}^{(q)}[n] sequence whose signal strength is larger than the threshold to be the TOA. In one embodiment, the TOA regarding target message may be estimated as t_{q}+ζ₃. In one embodiment, the above i-th message is defined as “the nearest TOA message” like the arrows 820 in the graph 800, since the message whose samples are relatively near the arrival signal. In one embodiment, the “nearest TOA message” may be also found as described below.

∵ The receiver has received M messages which are sampled as: y_{d}⁽ⁱ⁾ [n]=y(n×T_{S}+τᵢ) for 1≦i≦M
∴ Then, for y_{d}^{(q)}[n] message as the target message, the “nearest TOA message” y_{d}^{(Nearest)}[n]=y(n×T_{S}+τ_{Nearest}) is

$${y}_{d}^{( Nearest )} [ n ] \vert {τ}_{Nearest} = arg {min}_{i ∈ [ 1 , M ]} \{ {τ}_{i} - {τ}_{q} \}$$

$$where {τ}_{i} - {τ}_{q} = \frac{∠ {Y}_{d}^{i} [ {F}_{l} ] - ∠ {Y}_{d}^{q} [ {F}_{l} ]}{2 π ( \frac{{F}_{l}}{N {T}_{S}} )} , \\ for {F}_{l} ∈ [ 0 , 1 , 2 , … , ( \frac{N}{2} - 1 ) ] .$$

AOA performance is decided by the number of antennas and multi-paths. When incoming messages suffer multipath affection, the received signal is the combination of rays with different angles. The conventional approaches to identify the angle with respect to each ray from different path use techniques that use subspace decomposition of the autocorrelation matrix. By finding eigenvectors and an inverse matrix, the algorithms can return angle information with each ray. However, which ray represents the LOS is still not clear, such that the AOA information is not able to be obtained. Another approach is the joint angle and delay estimation (JADE) method. Although this approach is able to find the AOA with respect to LOS, it requires a large matrix over the previous conventional AOA algorithm to calculate these two parameters, and the complexity cost is extremely high.

In one embodiment, AOA is determined by exploiting channel information from the frequency domain. In one embodiment, once a channel impulse response is obtained, the LOS with its direction angle may be obtained. In one embodiment, the received message is defined as:

y^{(a)}(t)=γ₀^{(a)}×(t−τ₀)+Σ_{I=1}^{N}^{ₚ}⁻¹γₗ^{(a)}×(t−τl)+n^{(a)}(t) for a=1,2, . . . N_{A}

where
x(□): is the message
γ₀^{(a)}: is line of sight channel coefficient at a-th antenna
γₗ^{(a)}: is non-line of sight channel coefficient at a-th antenna respect to l-th path
N_{P}: is the numbers of paths and
N_{A}: is the numbers of antennas.

In one embodiment, it is assumed that antenna arrays are as in system 610 (FIG. 5B), where each antenna array spacing is ½ wavelength. Then, in one embodiment the LOS ray's angle φ may be calculated by averaging

$$φ = \frac{1}{{N}_{A} - 1} {\sum }_{a = 2}^{{N}_{A}} arccos ( \frac{{∠γ}_{0}^{( a )} - {∠γ}_{0}^{( 1 )}}{2 π} \times \frac{λ}{{d}_{a , 1}} )$$

where
N_{A}: is the numbers of antennas
γ₀^{(a)}: is line of sight gain at a-th antenna
yₗ^{(a)}
λ: is the wavelength of signal
and
d_{a,1}: is the distance between a-th and 1^{st} antenna

### N_{P}

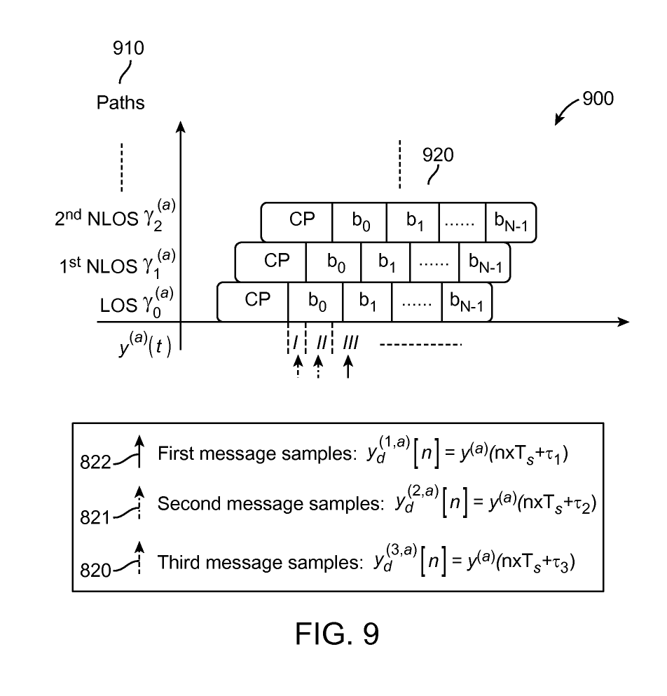

FIG. 9 shows an example graph 900 of AOA estimation vs. sampling position, according to an embodiment. In one embodiment, the LOS paths 910 are shown as are the first message samples 822, the second message samples 821, third message samples 820 and samples 920. In one embodiment, the channel impulse response may be obtained by using channel estimation from pilot assistances,

$${h}_{n}^{( i , a )} = IFFT \{ \frac{{Y}^{( i , a )} ( F )}{X ( F )} \}$$

$$for 1 \leq a \leq {N}_{A} , 1 \leq i \leq M and 0 \leq n \leq N - 1$$

where N is the FFT size, M is the numbers of messages and X(F) is the pilots in the frequency domain. However, the first element in channel impulse response from channel estimation may not be the LOS. Namely, h₀^{(i,a)}≠γ₀^{(a)} may not be held as the LOS. The reason is that the sampling positions of the message effect the channel estimation. In one embodiment, graph 900 is used to explain this phenomenon.

In one embodiment, when the sampling position is located in zones II and III, such as y_{d}^{(2,a)} and y_{d}^{(3,a)}, the first ray of the channel impulse response as well as the LOS will merge and reverse to the last element in hₙ^{(i,a)} such that h₀^{(i,a)}≠γ₀^{(a)}. In one embodiment, in order to obtain the LOS, the above approach is used to obtain the “nearest TOA message” which relative sampling position is near the arrival time. Therefore, in one embodiment, by using the “nearest TOA message” in the channel estimation, the channel impulse response may be obtained with a correct order such that h₀^{(Nearest,a)}=γ₀^{(a)} as shown as follows:

$${h}_{n}^{( Nearest , a )} = IFFT \{ \frac{{Y}^{( Nearest , a )} ( F )}{X ( F )} \}$$

$$for 0 \leq n \leq N - 1.$$

In one embodiment, the LOS's angle may be estimated by using the above equation which calculates the phase rotation among antennas of the AP Wi-Fi devices 140 (FIG. 2). When the number of multipaths increases, the conventional approaches require more antennas to estimate AOA. It may be noticed that the AOA solution in Table 1 above requires 16 antennas with frequency hopping (Bluetooth®) to overcome multipath affection. In one or more embodiments, it is unnecessary to increase the number of antennas, while the number of multipaths increases. In one example embodiment, the minimal requirement for antennas is two, which is affordable for regular Wi-Fi APs.

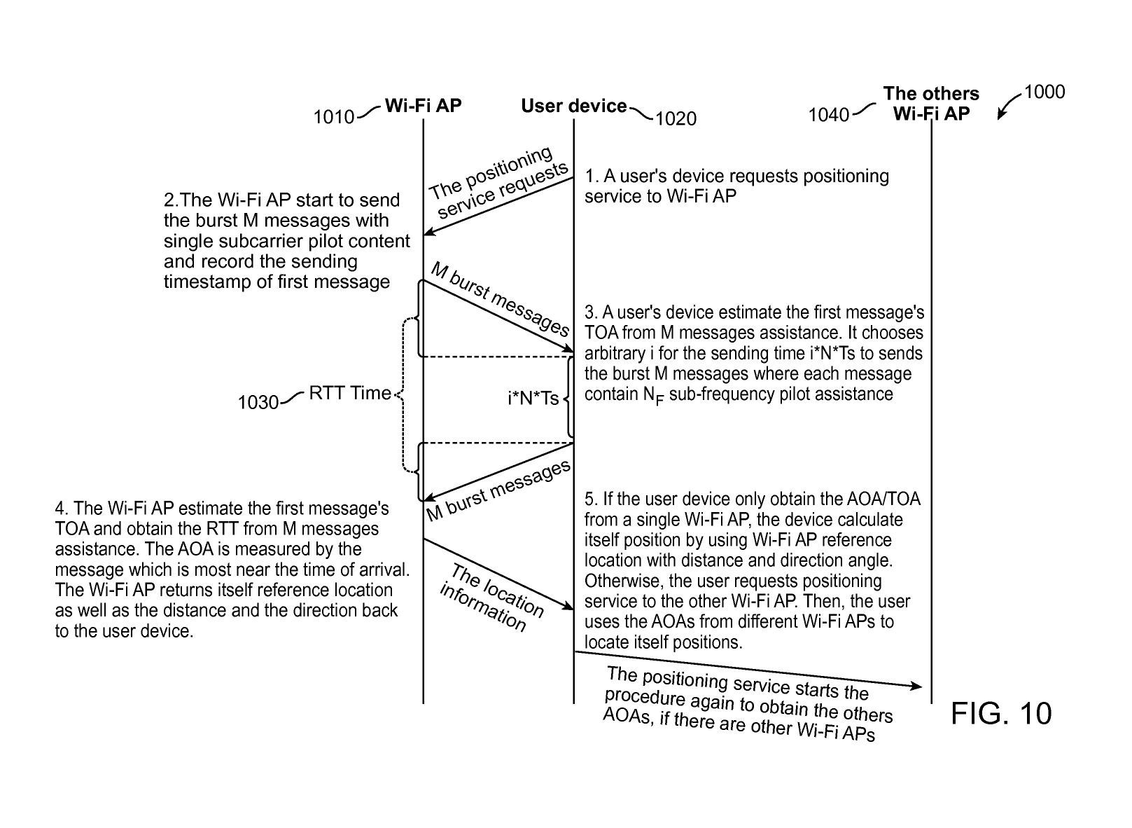

FIG. 10 shows an example timing-based flow diagram 1000, according to an embodiment. In one embodiment, the diagram 1000 indicates actions by the Wi-Fi AP device 1010 (e.g., Wi-Fi device 140, FIG. 2), a user device 1020 (e.g., electronic device 120) and other Wi-Fi AP devices 1040 (e.g., other Wi-Fi devices 140 or STAs). As described above, one or more embodiments showed the use of multiple messages (which have the same patterns of content, whether the same, different, or portion of the same and a portion of different content) including pilot assistances to obtain higher resolutions of the received signal. Hence, one or more embodiments show that the measurement of TOA/AOA is obtained with a high accuracy without the constraints of bandwidth.

The diagram 1000 shows the positioning procedure by applying the AOA/TOA determinations according to one or more embodiments. It is assumed that the Wi-Fi APs 1010 (and any APs 1040) have N_{A} antennas (N_{A}>1), while user devices 1020 have no restriction in the numbers of antennas. In addition, the FFT size is denoted as N and the sampling time period is denoted as Ts. In one embodiment, the positioning procedure and time-based flow is described follows.

1. User devices 1020
a user's device 1020 requests a positioning service to the Wi-Fi AP 1010.

2. Wi-Fi APs 1010
after granting the positioning request, the Wi-Fi AP 1010 starts to send the burst M messages and records the first sent message timestamp.
The content of each message is the same and contains a single sub-frequency pilot of an OFDM symbol.

3. User devices 1020:
The user device 1020 reconstructs the received signal by re-ordering the M messages with relative time differences.
The TOA regarding the first received message may be obtained from the reconstructed signal.
The user device 1020 chooses an arbitrary i for the sending time i*N*Ts to send the burst M messages where each message contains N_{F} sub-frequency pilot assistances.

4. Wi-Fi APs 1010
The user device reconstructs the received signal by re-ordering the M message with relative time differences.
The AOA is measured by the message which is nearest to the TOA.
The TOA regarding the first received message may be obtained from the reconstructed signal.
The distances are determined as the round trip time 1030 (RTT) multiplied by the speed of light (C) divided by 2, where the round trip is the time difference between the sending time and the received time.
The Wi-Fi AP 1010 returns its reference location as well as the distance and the direction back to the user device 1020.

5. User devices 1020
If the user device 1020 only obtains the AOA/TOA from a single Wi-Fi AP 1010, then the user device 1020 calculates its position by using the Wi-Fi AP 1010 reference location with the distance and direction angle as shown in FIG. 5A.

If the user device 1020 has the AOAs/TOAs from more than one Wi-Fi APs 1040, the user device 1020 only uses AOAs to deduce its own position by combining direction with each Wi-Fi AP as shown in FIG. 5B.

In one embodiment, the RTT 1030 approach is used to obtain distance for time synchronization free purposes. Since OFDM symbols have a cyclic repeating property, the user device 1020 may choose the i*N*Ts after receiving the first arrival message to send back, such that the phase of the received signal in the I-Q domain remains the same for Wi-Fi APs 1010 (and 1040). In one embodiment, by doing so, a user device 1020 is not required to send the message immediately, which results in processing delays and effects distance accuracy. Instead, in one example embodiment a user device 1020 stores the M messages in a buffer in advance. In one embodiment, after obtaining the arrival time, the user device 1020 then randomly chooses i*N*Ts to trigger the buffer sending out the burst M messages. For one or more embodiments, this mechanism reduces the processing delays during the calculation of message arrival time and sending packets to the buffer.

In one embodiment, the RTT 1030 time in the Wi-Fi AP 1010 is calculated using i*N*Ts. In one embodiment, the RTT 1030 time may be calculated by

RTT=(T_{R}−T_{S})MODULO NT_{S},

where
t_{R}: the received timestamp calculated by using reconstruction and
t_{S}: the sending timestamp recorded by the Wi-Fi AP.

In one embodiment, since the OFDM symbol cyclic property is applied, the Wi-Fi measurement distance is also limited by this property. Therefore, in one or more embodiments the distance measurement is computationally affordable as it is within one OFDM symbol without having ambiguity. Nevertheless, the computationally affordable distance measurement is still large. In one example, (e.g., IEEE 802.11ac) where the sampling rate is 20 MHz and the FFT size is 64, the computationally affordable distance is (64*50 ns*3e⁸)=3200 meters, which is far away from the Wi-Fi signal strength ability. In one example embodiment, the distance between the user device 1020 and the Wi-Fi AP 1010 is calculated by

$$Distacne = \frac{RTT}{2} \times light \text{-} speed .$$

In one embodiment, Wi-Fi APs 1010 (and 1040) measure the incoming messages direction by calculating the AOA as previously described.

In one or more embodiments, multiple messages are transmitted to obtain precise TOA and AOA information. In one embodiment, a message may be a signal, which only contains one OFDM sub-carrier; an OFDM symbol; a physical layer (PHY) preamble; a PHY frame with only a PHY preamble and a PHY header; a medium access control (MAC) frame with only a PHY preamble, a PHY header and MAC header; a regular MAC frame; etc. In one embodiment, for all message formats the sampling may be at a predefined fixed position for all messages.

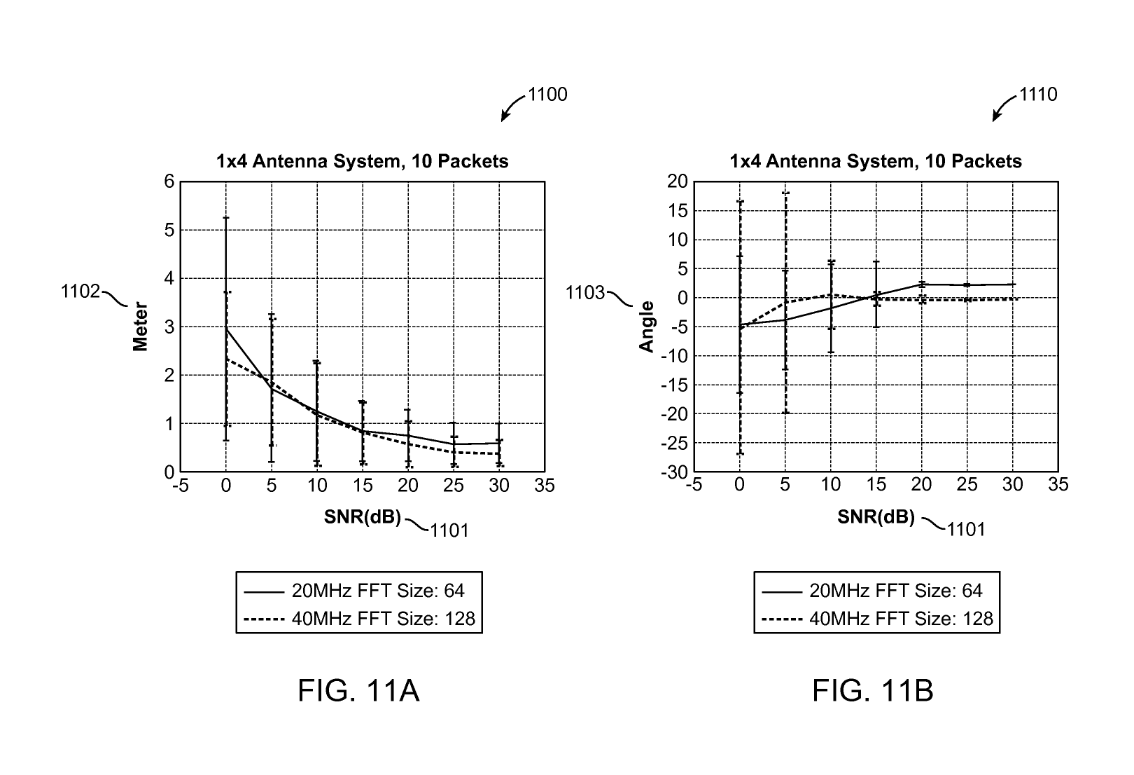

FIG. 11A shows an example graph 1100 of TOA performance for a sample of ten (10) packets, according to an embodiment. In one example, the graph 1100 shows distance measurement in meters 1102 versus signal to noise ratio (SNR) (dB) 1101. FIG. 11B shows an example graph 1110 of AOA performance for a sample of ten (10) packets, according to an embodiment. In one example, the graph 1110 shows the angle 1103 versus SNR (dB) 1101. In one embodiment, the distance error depends on both sides TOA measurement and numbers of packets with their time distances. For the simulations depicted in the graphs 1100 and 1110, the assumed sampling rates are 20M/40M Hz, and FFT sizes are 64/128. In addition, each Wi-Fi AP device 140 (FIG. 2) is assumed to have 4 antennas, while the user device (e.g., electronic device 120) has a single antenna. For each message, the time between each other is assumed to be Ts/M where M is the number of burst messages. For graphs 1100 and 1110, M=10 packets and 16 pilots assistance for FFT size 64.

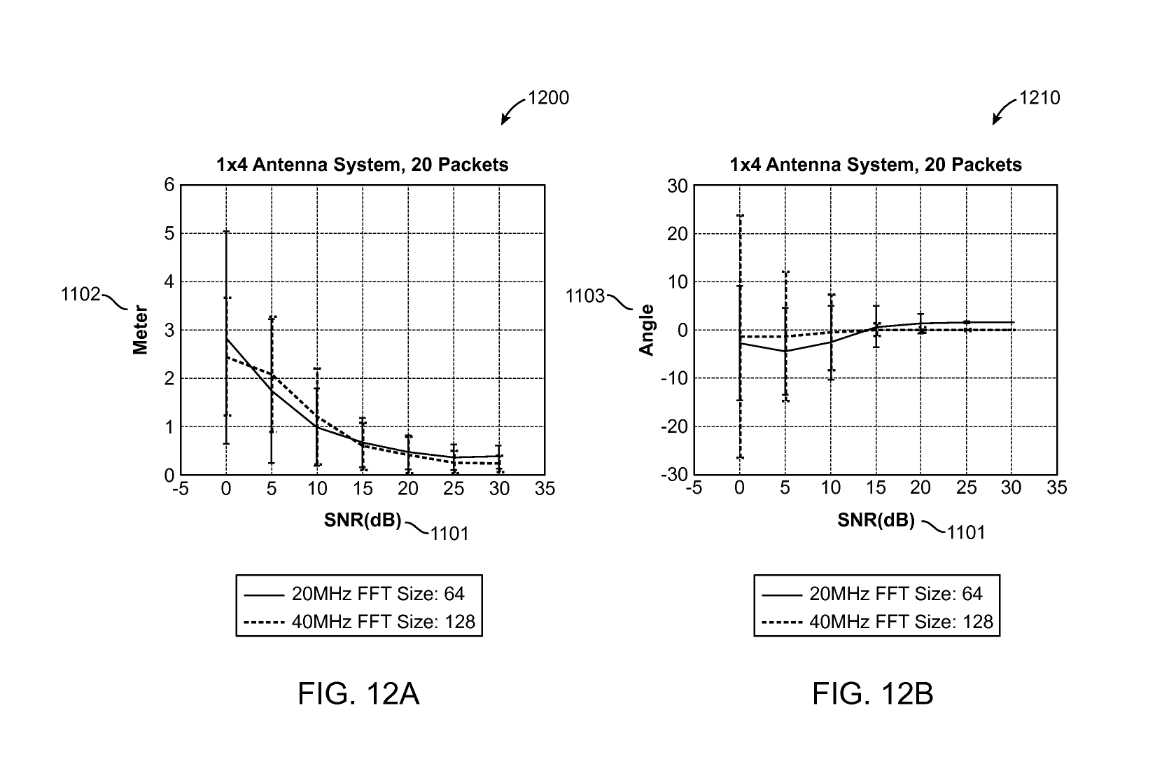

FIG. 12A shows an example graph 1200 of TOA performance for a sample of twenty (20) packets, according to an embodiment. FIG. 12B shows an example graph 1210 of AOA performance for a sample of twenty (20) packets, according to an embodiment. For graphs 1200 and 1210, M=20 packets and 32 pilots assistance for FFT size 128. In one example embodiment, since for graphs 1100, 1110/1200, 1210 the assumptions used are 16/32 pilots for FFT Size N=64/128, the 32 pilots assistance in FFT 128 has less signal strength in time domain. The reason is the maximal power of signal transmission is fixed, and the 32 pilots for FFT size 128 have in total less power than 16 pilots for FFT size 64. Hence, the performance for the message with 32 pilots in low SNR is poorer than the message with 16 pilots.

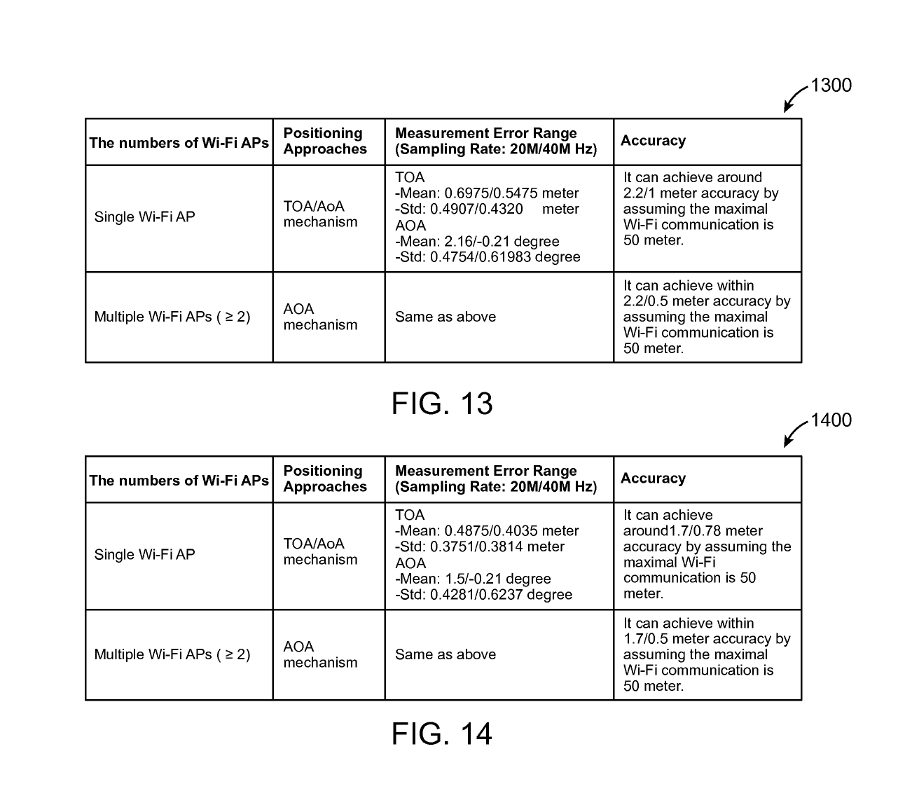

FIG. 13 shows an example chart 1300 of positioning performance for a sample of ten (10) packets, according to an embodiment. FIG. 14 shows an example chart 1400 of positioning performance for a sample of twenty (20) packets, according to an embodiment. In one embodiment, when the SNR is higher, the TOA/AOA for the message with 32 pilots is much better than the message with 16 pilots. Namely, the sampling rate of 40 MHz and channel estimation from 32 pilots returns better performance.

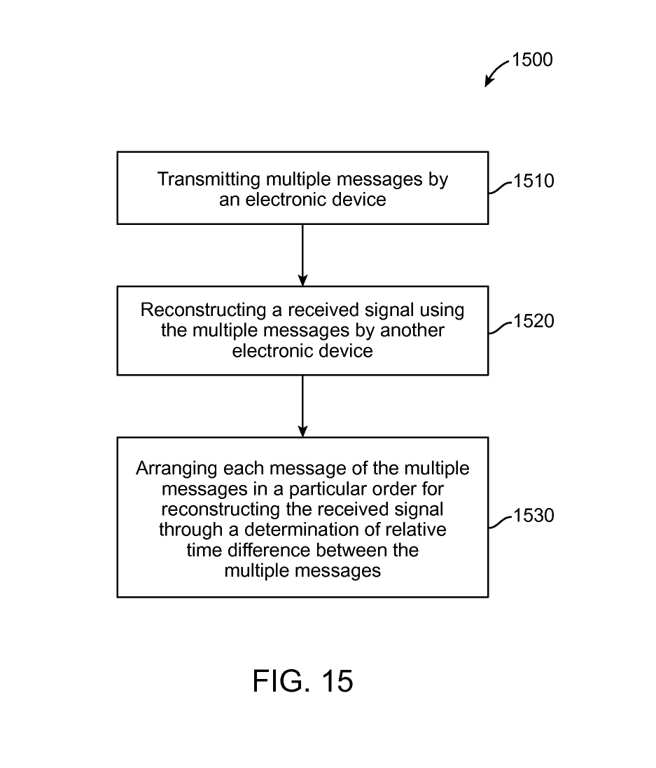

FIG. 15 shows a process 1500 for Wi-Fi positioning, according to one embodiment. In one embodiment, in block 1510 process 1500 performs transmitting multiple messages by an electronic device (e.g., electronic device 120, FIG. 2). In one embodiment, process 1500 includes in block 1520, reconstructing a received signal using the multiple messages by another electronic device (e.g., another electronic device 120, STA, AP, etc.). In one embodiment, in block 1530 process 1500 provides arranging each message of the multiple messages in a particular order for reconstructing the received signal through a determination of relative time difference between the multiple messages. In one embodiment, process 1500 may further provide for estimating TOA using the reconstructed received signal. In one embodiment, the reconstructed received signal that includes a combination of the multiple messages in an order based on relative time difference. In one embodiment, process 1500 may further provide for determining an AOA through channel estimation by utilizing a particular message closest to the TOA. In one embodiment, position of the electronic device is determined based on one or more of the positioning information and the AOA.

In one embodiment, the process 1500 may include requesting positioning service by the electronic device to at least one AP or STA, sending burst messages to the electronic device from the at least one AP, and recording time information for a first message sent by the at least one AP or STA. In one embodiment, in process 1500 may provide that each message sent by the at least one AP or STA comprises a same message content, different message content, or a portion of same content and a portion of different content, and contains at least one sub-frequency pilot signal of an OFDM symbol.

In one embodiment, process 1500 may include reconstructing the received signal by re-ordering the messages with a relative time difference, wherein the electronic device selects an arbitrary value for a sending time to send the burst messages. In one embodiment, process 1500 may provide that each burst message includes a signal that comprises one of: a single OFDM sub-carrier, an OFDM symbol, a physical layer (PHY) preamble, a PHY frame with only a PHY preamble and a PHY header, a medium access control (MAC) frame, or a MAC frame with only a PHY preamble, a PHY header and a MAC header. In one embodiment, for all message formats a sampling comprises a predefined fixed position for all messages.

In one embodiment, process 1500 may provide that the positioning information includes one or more of a reference location, distance information and direction information. In one embodiment, process 1500 may provide that the at least one AP or STA determines distance based on RTT, where the RTT includes a time difference between message sending time and message received time. In one embodiment, the message sending time and the message received time are determined by using the combination of the multiple messages in the order based on the relative time difference.

In one embodiment, process 1500 may provide that for a single AP or STA, the electronic device determines position of the electronic device by using the reference location with the distance and the direction information that includes a direction angle. In one embodiment, process 1500 may provide that for more than one APs or STAs communicating with the electronic device, the electronic device estimates more than one TOA and the more than one APs or STAs each determining an AOA, and the electronic device only uses the AOA determinations for computing its position based on combining directions from the more than one APs or STAs. In one embodiment, process 1500 may provide that the position is determined indoors within a structure (e.g., a dwelling, a shopping mall, an indoor event with available Wi-Fi, a building, etc.) using Wi-Fi signals.

In one or more embodiments, the positioning determinations of one or more embodiments, as described above, may be used for different applications, such as targeting content on a display based on position of an electronic device 120 (FIG. 2), targeting audio, providing different information to an electronic device 120 based on position, etc.

One or more embodiments may use a TOA measurement approach based on: (a) applying multiple received messages with phase rotation to assemble discrete time samples in terms of each message of its relative time difference for TOA estimation; (b) each message uses the same predefined message that contains at least a single sub-carrier frequency as pilots; (c) a message may be a signal that only contains one OFDM sub-carrier only, an OFDM symbol, a PHY preamble, a PHY frame with only a PHY preamble and a PHY header, a MAC frame with only a PHY preamble, a PHY header and a MAC header, or a regular MAC frame (for all message formats the sampling will be at a predefined fixed position for all messages); (d) the TOA is estimated by using a reference message (such as the first message with the time difference from the message that is nearest the time of arrival), where the calculation is the time stamp of the reference message, such as the first message with the time difference from nearest TOA message.

One or more embodiments may use an AOA measurement approach based on: (a) applying the channel estimation approach with the received message that is a nearest TOA signal amongst others to calculate the LOS ray information: (i) the AOA may be estimated by using the LOS ray information among multiple antennas; (ii) applying the phase rotation technique to find out a nearest TOA signal amongst others; and (b) each message is using the same predefined message that contains multiple sub-carrier frequency as pilots.

One or more embodiments may locate an electronic device 120 (FIG. 2) position through a single Wi-Fi router through a TOA/AOA Hybrid System based on: (a) a hybrid system utilizing multiple messages with phase rotation to estimate TOA in high resolution for measuring distance, (i) where the distance is calculated by using RTT through the multiple messages of both sides (e.g., a Wi-Fi router side and the electronic device 120 side); (b) a hybrid system estimates the AOA by finding the message who is nearest a TOA arrival among multiple messages through a phase rotation calculation, (i) where the AOA is calculated by using channel estimation to obtain LOS among antennas; and (3) the positioning is located by combining the distance and angle information.

One or more embodiments may locate an electronic device 120 (FIG. 2) through multiple Wi-Fi routers based on using AOA by: (a) each Wi-Fi system estimates the AOA by finding the message that is nearest to the TOA arrival among multiple messages through a phase rotation calculation: (i) where the AOA is calculated by using channel estimation to obtain LOS among antennas; and (2) the positioning is located by combining the AOA information among the different Wi-Fi routers.

One or more embodiments may locate an electronic based on the electronic device's 120 (FIG. 2) relative position through another object, such as the relative position between an electronic device 120 with another electronic device 120 by using a TOA/AOA Hybrid System based on: (a) a hybrid system utilizing multiple messages with phase rotation to estimate TOA in high resolution for measuring distance, (i) where the distance is calculated by using RTT through the multiple messages of both sides (e.g., electronic device 120 and Wi-Fi sides); and (b) the hybrid system estimates the AOA by finding the message that is a nearest TOA arrival among multiple messages through a phase rotation calculation, (i) where the AOA is calculated by using channel estimation to obtain a LOS among antennas; and (c) the positioning is located by combining the distance and angle information.

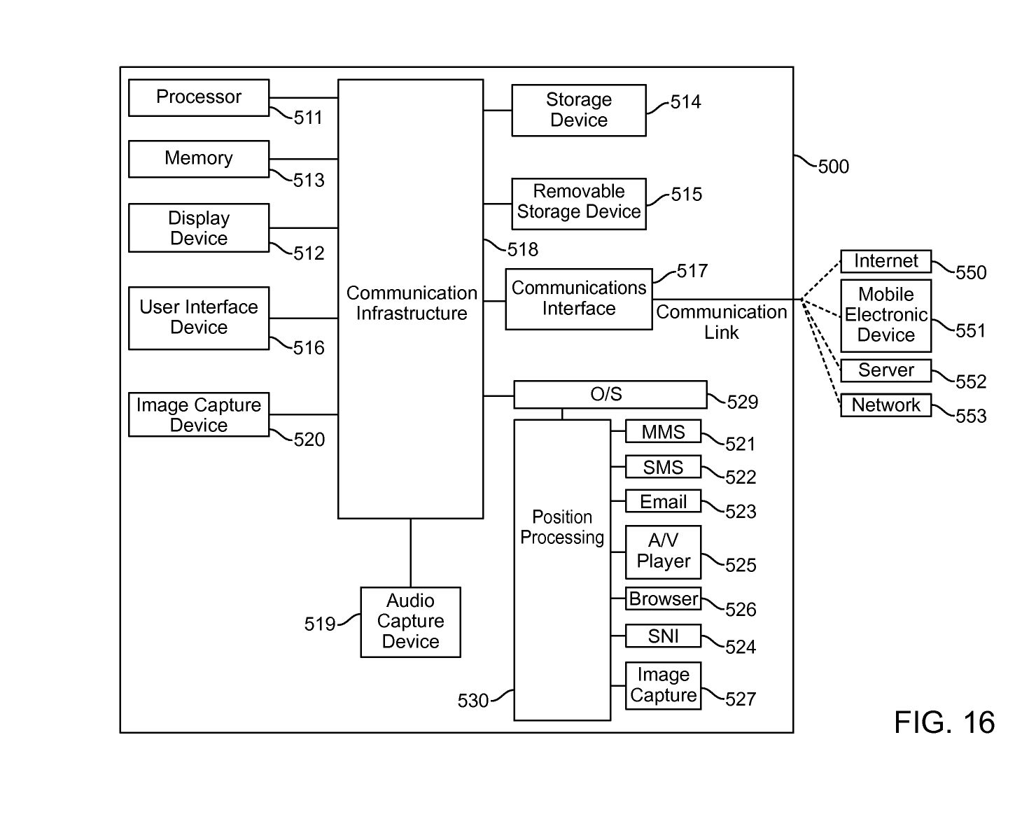

FIG. 16 is a high-level block diagram showing an information processing system comprising a computing system 500 implementing one or more embodiments. The system 500 includes one or more processors 511 (e.g., ASIC, CPU, etc.), and may further include an electronic display device 512 (for displaying graphics, text, and other data), a main memory 513 (e.g., random access memory (RAM), cache devices, etc.), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as Wi-Fi, Cellular), a network interface (such as an Ethernet card), a communications port, or a PCMCIA slot and card).

The communication interface 517 allows software and data to be transferred between the computer system and external devices through the Internet 550, mobile electronic device 551, a server 552, a network 553, etc. The system 500 further includes a communications infrastructure 518 (e.g., a communications bus, cross bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of one or more embodiments in a mobile wireless device (e.g., a mobile phone, smartphone, tablet, mobile computing device, wearable device, etc.), the system 500 further includes an image capture device 520, such as a camera 128 (FIG. 2), and an audio capture device 519, such as a microphone 122 (FIG. 2). The system 500 may further include application modules as MMS module 521, SMS module 522, email module 523, social network interface (SNI) module 524, audio/video (AV) player 525, web browser 526, image capture module 527, etc.

In one embodiment, the system 500 includes position processing module 530 that may implement Wi-Fi positioning features of system 100, 60 and 610 and processing similar as described regarding (FIG. 3), and processing as described with reference to the timing diagram 1000 (FIG. 10). In one embodiment, the position processing module 530 may implement the flow diagram 1500 (FIG. 15). In one embodiment, the position processing module 530 along with an operating system 529 may be implemented as executable code residing in a memory of the system 500. In another embodiment, the position processing module 530 may be provided in hardware, firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for Wi-Fi positioning comprising:
transmitting multiple messages by an electronic device;
reconstructing a received signal using the multiple messages by another electronic device; and
arranging each message of the multiple messages in a particular order for reconstructing the received signal through a determination of relative time difference between the multiple messages.

2. The method of claim 1, further comprising:
estimating time of arrival using the reconstructed received signal that comprises a combination of the multiple messages in an order based on relative time difference; and
determining an angle of arrival through channel estimation by utilizing a particular message closest to the time of arrival.

3. The method of claim 2, further comprising:
receiving, by the electronic device positioning information; and
determining position of said another electronic device based on one or more of the positioning information and the angle of arrival.

4. The method of claim 1, further comprising:
requesting positioning service by the electronic device to at least one of an access point (AP) and a station device (STA); and
sending burst messages to the electronic device from the at least one of the AP and the STA, and recording time information for a first message sent by the at least one of the AP and the STA.

5. The method of claim 4 wherein each message sent by the at least one AP comprises one of a same message content, a different message content and a portion of a same message content and a different message content, and contains at least one sub-frequency pilot signal of an orthogonal frequency-division multiplexing (OFDM) symbol.

6. The method of claim 5, wherein reconstructing the received signal comprises re-ordering the messages with a relative time difference, wherein the electronic device selects an arbitrary value for a sending time to send the burst messages, wherein, each burst message includes a signal that comprises one of: a single OFDM sub-carrier, an OFDM symbol, a physical layer (PHY) preamble, a PHY frame with only a PHY preamble and a PHY header, a medium access control (MAC) frame, or a MAC frame with only a PHY preamble, a PHY header and a MAC header, wherein for all message formats a sampling comprises a predefined fixed position for all messages.

7. The method of claim 6, wherein the positioning information comprises one or more of a reference location, distance information and direction information, and wherein the at least one AP or the STA determines distance based on round trip time (RTT), wherein the RTT comprises a time difference between message sending time and message received time, wherein the message sending time and the message received time are determined by using the combination of the multiple messages in the order based on the relative time difference.

8. The method of claim 7, wherein for a single AP or a single STA, the electronic device determines position of the electronic device by using the reference location with the distance and the direction information that comprises a direction angle.

9. The method of claim 7, wherein for more than one APs or more than one STAs communicating with the electronic device, the electronic device estimating more than one time of arrival and the more than one APs or the more than one STAs each determining an angle of arrival, and the electronic device only using the angle of arrival determinations for computing its position based on combining directions from the more than one APs or the more than one STAs.

10. The method of claim 1, wherein the electronic device comprises a mobile electronic device.

11. The method of claim 10, wherein the position is determined indoors within a structure using Wi-Fi signals.

12. A system comprising:
one or more access points (APs) or station devices (STAs); and
an electronic device that reconstructs a received signal from the one or more APs or STAs using multiple messages, the electronic device further arranging each message of the multiple messages in a particular order for reconstructing the received signal through a determination of relative time difference between the multiple messages.

13. The system of claim 12, wherein the electronic device estimates time of arrival using the reconstructed received signal,
wherein the one or more APs or STAs determine an angle of arrival based on a particular message closest to the time of arrival, and transmits positioning information to the electronic device.

14. The system of claim 13, wherein the electronic device determines its position based on one or more of the positioning information and the angle of arrival.

15. The system of claim 14, wherein the electronic device requests positioning service from the one or more APs or STAs and the one or more APs or STAs send burst messages to the electronic device, wherein the one or more APs or STAs record time information for a first message sent.

16. The system of claim 15, wherein each message sent by the one or more APs or STAB comprises one of a same message content, different message content and a portion of a same message content and a different message content, and contains at least one sub-frequency pilot signal of an orthogonal frequency-division multiplexing (OFDM) symbol.

17. The system of claim 16, wherein the electronic device reconstructs the received signal based on re-ordering the messages with a relative time difference, wherein the electronic device selects an arbitrary value for a sending time to send the burst messages to the one or more APs or STAB, and wherein each burst message includes a signal that comprises one of: a single OFDM sub-carrier, an OFDM symbol, a physical layer (PHY) preamble, a PHY frame with only a PHY preamble and a PHY header, a medium access control (MAC) frame, or a MAC frame with only a PHY preamble, a PHY header and a MAC header, wherein for all message formats a sampling comprises a predefined fixed position for all messages.

18. The system of claim 17, wherein the positioning information comprises one or more of a reference location, distance information and direction information, and the one or more APs or STAs determine distance based on round trip time (RTT), wherein the RTT comprises a relative time difference between message sending time and message received time, wherein the message sending time and the message received time are determined by using a combination of the multiple messages in an order based on the relative time difference.

19. The system of claim 18, wherein for a single AP or a single STA, the electronic device determines its position by using the reference location with the distance and the direction information that comprises a direction angle.

20. The system of claim 18, wherein for more than one APs or STAs communicating with the electronic device, the electronic device estimates more than one time of arrival and the more than on APs or STAs each determine an angle of arrival, and the electronic device only uses the angle of arrival determinations for computing its position based on combining directions from the more than one APs or STAs.

21. The system of claim 12, wherein the electronic device comprises a mobile electronic device, and the position is determined indoors within a structure using Wi-Fi signals.

22. A non-transitory computer-readable medium having instructions which when executed on a computer perform a method comprising:
transmitting multiple messages from an electronic device;
reconstructing a received signal using the multiple received messages by another electronic device; and
arranging each message of the multiple messages in a particular order for reconstructing the received signal through a determination of relative time difference between the multiple messages.

23. The medium of claim 22, further comprising:
estimating time of arrival using the reconstructed received signal that comprises a combination of multiple messages in an order of relative time difference; and
determining an angle of arrival through channel estimation by utilizing a particular message closest to the time of arrival.

24. The medium of claim 22, further comprising:
receiving, by the electronic device, positioning information; and
determining position of the electronic device based on one or more of the positioning information and the angle of arrival.

25. The medium of claim 24, further comprising:
requesting positioning service by the electronic device to at least one access point (AP) or station device (STA);
sending burst messages to the electronic device from the at least one AP or STA; and
recording time information for a first message sent by the at least one AP or STA.

26. The medium of claim 25, wherein each message sent by the at least one AP or STA comprises one of a same message content, different message content and a portion of a same message content and a different message content, and contains at least one sub-frequency pilot signal of an orthogonal frequency-division multiplexing (OFDM) symbol.

27. The medium of claim 25, wherein reconstructing the received signal comprises re-ordering the messages with a relative time difference, wherein the electronic device selects an arbitrary value for a sending time to send the burst messages, and wherein each burst message includes a signal that comprises one of: a single OFDM sub-carrier, an OFDM symbol, a physical layer (PHY) preamble, a PHY frame with only a PHY preamble and a PHY header, a medium access control (MAC) frame, or a MAC frame with only a PHY preamble, a PHY header and a MAC header, wherein for all message formats a sampling comprises a predefined fixed position for all messages, and the positioning information comprises one or more of a reference location, distance information and direction information.

28. The medium of claim 27, wherein the at least one AP or STA determines distance based on round trip time (RTT), wherein the RTT comprises a time difference between message sending time and message received time, wherein the message sending time and the message received time are determined by using the combination of the multiple messages in the order based on the relative time difference.

29. The medium of claim 28, wherein:
for a single AP or STA, the electronic device determines position of the electronic device by using the reference location with the distance and the direction information that comprises a direction angle; and
for more than one APs or STAs communicating with the electronic device, the electronic device estimating more than one time of arrival and the more than one APs or STAs each determining angle of arrival, and the electronic device only using the angle of arrival determinations for computing its position based on combining directions from the more than one APs or STAs.

30. The medium of claim 22, wherein the electronic device comprises a mobile electronic device, and the position is determined indoors within a structure using Wi-Fi signals.
